(19) United States
(12) Patent Application Publication
(10) Pub. No.: US 2009/0039540 A1
(43) Pub. Date: Feb. 12, 2009

(54) REINFORCED ELECTROLYTE MEMBRANE COMPRISING CATALYST FOR PREVENTING REACTANT CROSSOVER AND METHOD FOR MANUFACTURING THE SAME

(76) Inventor: Yasunori Nouji, Aichi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/282,741

(22) PCT Filed: Mar. 7, 2007
(86) PCT No.: PCT/JP2007/055009

§ 371 Date: Sep. 12, 2008

(30) Foreign Application Priority Data
Mar. 14, 2006 (JP) 2006-069441

(51) Int. Cl. C04B 35/52; H01M 8/10

(52) U.S. Cl. 264/105; 429/30

(57) ABSTRACT

An object of the present invention is to reduce the amount of hydrogen gas permeating an electrolyte membrane to inhibit cross leak, in which hydrogen reacts with oxygen to thermally degrade the membrane, while improving the mechanical strength of the fuel cell to increase its durability and lifetime. The present invention provides a fuel cell reinforcing electrolyte membrane reinforced by a porous membrane, wherein noble metal carrying carbon is present on a surface of and/or in pores in the porous membrane, said membrane being covered by electrolyte layers.

### TECHNICAL FIELD

The present invention relates to reinforcing electrolyte membranes for use in fuel cells, methods for manufacturing reinforcing electrolyte membranes for use in fuel cells, fuel cell membrane-electrode assemblies, and solid polymer fuel cells comprising reinforcing electrolyte membranes for use in fuel cells.

### BACKGROUND ART

Fuel cells, which generate electricity by an electrochemical reaction of gas, offer high generation efficiencies and emit clean gas that exerts few adverse effects on environments. In recent years, various applications such as generation and low-pollution vehicle power sources have been expected for the fuel cells. The fuel cells can be classified according to their electrolytes; known fuel cells include a phosphoric acid type, a molten carbonate type, a solid oxide type, and a solid polymer type.

In particular, the solid polymer fuel cell can be operated at a low temperature of about 80° C. and thus handled more easily than the other types of fuel cells. The solid polymer fuel cell also has a very high output density and is expected to be used for various applications. The solid polymer fuel cell normally has, as a generation unit, a membrane-electrode assembly (MEA) having a proton-conductive polymer membrane as an electrolyte and a pair of electrodes provided on the respective sides of the polymer membrane and constituting a fuel electrode and an oxygen electrode. The fuel electrode is supplied with fuel gas such as hydrogen or hydrocarbon. The oxygen electrode is supplied with oxidizer gas such as oxygen or air. This causes an electrochemical reaction at a three-phase interface between the gas and the electrolyte and the electrodes to generate electricity.

The solid polymer fuel cell comprises a laminate of a membrane-electrode assembly and separators. The membrane-electrode assembly comprises an electrolyte membrane composed of an ion exchange membrane, an electrode (anode, fuel electrode) located on one of surfaces of the electrolyte membrane and composed of a catalyst layer, and an electrode (cathode, air electrode) located on the other surface of the electrolyte membrane and composed of a catalyst layer. A diffusion layer is provided between the membrane-electrode assembly and each of the anode side separator and the cathode side separator. A fuel gas channel is formed in one of the separators for supplying the anode with the fuel gas (hydrogen). An oxide gas channel is formed in the other separator for supplying the cathode with the oxidizing gas (oxygen, normally air). A solvent channel is also formed in each separator so that a solvent (normally, cooling water) flows through the solvent channel. The membrane-electrode assembly and the separators are laid on top of one another to form a cell. At least one cell is used to form a module. Modules are laminated together to form a cell laminate. Then, a terminal, an insulator, and an endplate are placed at each of the opposite ends of the cell laminate in a cell laminating direction. The cell laminate is tightened in the cell laminating direction and fixed, via bolts and nuts, to a tightening member extending in the cell laminating direction outside the cell laminate. A stack is thus formed.

A reaction occurs on the fuel electrode (anode) side of each cell to convert hydrogen into hydrogen ions (protons) and electrons. The hydrogen ions migrate through the electrolyte membrane to the cathode, at which oxygen and the hydrogen ions and electrons (electrons generated by the fuel electrode of the adjacent MEA migrate through the separator to the cathode or electrons generated by the fuel electrode of the cell at one end in the cell laminating direction migrate through an external circuit to the air electrode (cathode) of the cell at the other end) react with one another to generate water as shown below.

Anode side: H₂→2H⁺+2e⁻
Cathode side: 2H⁺+2e⁻+(½)O₂→H₂O

The electrolyte membrane is to migrate only protons through the membrane across the membrane thickness. However, a trace amount of hydrogen may migrate across the membrane thickness from the fuel electrode (anode) toward the air electrode (cathode) or vice versa. This is called cross leak.

Thus, in the solid polymer fuel cell, what is called a cross leak problem may disadvantageously occur; the gases supplied to the two electrodes may partly diffuse through the electrolyte to the opposite electrodes without contributing to the electrochemical reaction and mix with the gases supplied to the respective electrodes. The cross leak may lower the cell voltage or energy efficiency. Moreover, a burning reaction resulting from the cross leak may degrade the polymer membrane, an electrolyte, to prevent the fuel cell from functioning properly.

On the other hand, a reduction in the thickness of the polymer membrane, an electrolyte, has been proposed in order to reduce the internal resistance of the cell, while increasing its power. However, a thinner polymer membrane allows the gases to diffuse more easily, making the cross leak problem more serious. Further, the reduced thickness reduces the mechanical strength of the polymer membrane itself and allows pin holes or the like to be more easily created during the manufacture of polymer membranes. These defects in the polymer membrane itself are a factor increasing the possibility of cross leak.

Thus, various efforts have been made to inhibit cross leak. For example, JP Patent Publication (Kokai) No. H06-84528 A(1994) discloses an attempt to inhibit cross leak by laminating a plurality of polymer membranes used as electrolytes to one another to displace pin holes created in the polymer membranes with respect to one another. Further, to reinforce the polymer membrane itself, for example, JP Patent Publication (Kokai) No. 2001-35508 A discloses a polymer membrane reinforced by fibers or the like.

However, the laminate of the polymer membranes is only composed of several laminated identical polymer membranes and only has its membrane thickness increased. That is, the mechanical strength of the polymer membranes is insufficient, making it difficult to inhibit cross leak over a long use period. Further, in a method for reinforcing the polymer membranes with fibers or the like, the process of manufacturing polymer membranes is complicated and expensive. In spite of improving the strength of the polymer membranes, this method fails to sufficiently inhibit cross leak.

JP Patent Publication (Kokoku) No. H06-022144 B(1994) discloses a fuel cell with a crossover prevention layer provided in an electrolyte matrix; the crossover prevention layer is formed of a catalytic impalpable powder, a hydrophilic impalpable powder, and a binder to provide a fuel cell that can suppress the degradation of its characteristics caused by crossover, prevent crossover without having its operation stopped, and operate stably over a long period.

The crossover prevention layer disclosed in JP Patent Publication (Kokoku) No. H06-022144 B(1994) exerts a specific effect for preventing the permeation of hydrogen gas or the like. However, this configuration does not reinforce the electrolyte membrane itself and thus offers an insufficient mechanical strength. Further, it is desirable to further reduce the amount of hydrogen permeating the electrolyte to improve the utilization efficiency of hydrogen and to inhibit the degradation of the electrolyte caused by the permeation of hydrogen to improve durability.

### DISCLOSURE OF THE INVENTION

In view of these circumstances, it is an object of the present invention to reduce the amount of hydrogen gas permeating an electrolyte membrane to inhibit cross leak, in which hydrogen reacts with oxygen to thermally degrade the membrane, while improving the mechanical strength of the fuel cell to reduce its durability and lifetime. Another object of the present invention is to provide a fuel cell membrane-electrode assembly that reduces the amount of permeating hydrogen gas to inhibit cross leak. Another object of the present invention is to provide a durable, high-power solid polymer fuel cell using the membrane-electrode assembly.

The present inventors have successfully made the present invention by finding that the above objects are accomplished using a reinforced electrolyte membrane having a specifically treated reinforcing layer.

First, the present invention provides a fuel cell reinforcing electrolyte membrane reinforced by a porous membrane, wherein noble metal carrying carbon is present on a surface of and/or in pores in the porous membrane. The porous membrane serves as a reinforcing layer to improve the mechanical strength. Since the noble metal carrying carbon is present on the surface of and/or in the pores in the porous membrane, hydrogen permeating the pores is expected to be protonated by a chemical catalytic action. Further, the noble metal carrying carbon is expected to physically obstruct the hydrogen permeating the pores. As a result, the fuel cell reinforcing electrolyte membrane in accordance with the present invention suppresses the permeation of hydrogen gas to increase the utilization efficiency of hydrogen. The fuel cell reinforcing electrolyte membrane also inhibits the degradation of the electrolyte caused by the permeation of hydrogen to improve durability.

The fuel cell reinforcing electrolyte membrane in accordance with the present invention basically comprises an electrolytic layer, a porous membrane reinforcing layer, and an electrolytic layer. The fuel cell electrolyte membrane reinforced by the porous membrane may comprise the porous membrane having the noble metal carrying carbon present on the surface thereof and/or in the pores therein and the polymer electrolyte with which the porous membrane is impregnated and/or which is laminated to the porous membrane.

The fuel cell reinforcing electrolyte membrane in accordance with the present invention is not limited to the basic structure comprising the electrolytic layer, porous membrane reinforcing layer, and electrolytic layer. The fuel cell reinforcing electrolyte membrane reinforced by the porous membrane may comprise one or more laminated sets of the polymer electrolyte membrane and the porous membrane.

In the fuel cell reinforcing electrolyte membrane in accordance with the present invention, a preferred example of the porous membrane functioning as a reinforcing layer is a polytetrafluoroethylene (PTFE) membrane made porous by drawing.

The noble metal is any of various metals used as catalysts in the field of solid polymer fuel cells. Among these metals, a preferred example is platinum (Pt).

Second, the present invention provides a method for manufacturing a fuel cell reinforcing electrolyte membrane, characterized by (1) a step of mixing a polymer material powder that can be formed into a porous membrane and a carbon powder and extruding the mixture to manufacture a carbon mixed polymer membrane, (2) a step of treating the carbon mixed polymer membrane with a compound solution having a noble metal ion seed to allow carbon present in the polymer membrane to carry the noble metal, (3) a step of drawing the polymer membrane to form a porous thin membrane, and (4) a step of impregnating and/or laminating the porous membrane having the noble metal carrying carbon present on a surface thereof and/or in pores therein, with and/or to a polymer electrolyte.

In the method for manufacturing a fuel cell reinforcing electrolyte film in accordance with the present invention, the order of the steps may be appropriately changed. For example, instead of (1)→(2) →(3) →(4), the order may be (1) →(3) →(2) →(4).

In the method for manufacturing a fuel cell reinforcing electrolyte membrane in accordance with the present invention, a preferred example of step of coating and/or precipitating the noble metal on the surface of and/or in the pores in the porous thin membrane is chemical plating or sputtering.

In the method for manufacturing a fuel cell reinforcing electrolyte membrane in accordance with the present invention, a preferred example of step of impregnating and/or laminating the porous membrane with and/or to the polymer electrolyte is casting or melt impregnation.

In the method for manufacturing a fuel cell reinforcing electrolyte membrane in accordance with the present invention, a preferred example of the polymer material that can be formed into the porous membrane is a polytetrafluoroethylene (PTFE) membrane, and a preferred example of the noble metal is platinum (Pt), as described above.

Third, the present invention provides a fuel cell membrane-electrode assembly (MEA) comprising the above fuel cell reinforcing electrolyte membrane, that is, a fuel cell membrane-electrode assembly including a pair of electrodes comprising a fuel electrode to which fuel gas is supplied and an oxygen electrode to which an oxidizer gas is supplied and a polymer electrolyte membrane sandwiched between the pair of electrodes, wherein the polymer electrolyte membrane is the above fuel cell reinforcing electrolyte membrane. In the fuel cell membrane-electrode assembly in accordance with the present invention, the polymer electrolyte membrane may include one or more fuel cell reinforcing electrolyte films.

Fourth, the present invention provides a solid polymer fuel cell comprising a membrane-electrode assembly having the above fuel cell reinforcing electrolyte membrane.

The present invention provides the fuel cell electrolyte membrane reinforced by the porous thin membrane having the noble metal carrying carbon present on the surface thereof and/or in the pores thereof. This fuel cell electrolyte membrane suppresses the permeation of hydrogen gas to increase the possibility that gas permeating the electrolyte membrane comes into contact with the noble metal. This inhibits cross leak, in which permeating hydrogen reacts with oxygen to thermally degrade the membrane, and also inhibits short circuiting resulting from the precipitation of the noble metal. The fuel cell electrolyte membrane offers a high mechanical strength because it is reinforced by the porous thin membrane. This reduces the durability and lifetime of the fuel cell. The use of the fuel cell membrane-electrode assembly inhibiting cross leak provides a durable, high-power solid polymer fuel cell.

### BRIEF DESCRIPTION OF THE DRAWINGS

FIG. 1 is a schematic diagram of an electrolyte membrane for a fuel cell reinforced by a porous membrane having a basic structure comprising an electrolyte layer 1, a porous membrane reinforcing layer 2, and an electrolyte layer 3.

### DESCRIPTION OF SYMBOLS

1: Electrolyte layer, 2: Porous reinforcing layer, 3: Electrolyte layer, 4: Noble metal carrying carbon

### BEST MODE FOR CARRYING OUT THE INVENTION

With reference to the drawings, description will be given of the functions of a fuel cell reinforcing electrolyte membrane in accordance with the present invention.

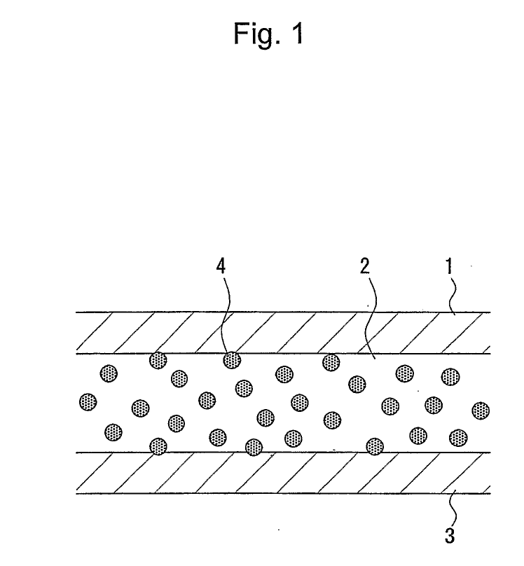

FIG. 1 shows the basic structure of a fuel cell electrolyte membrane reinforced by a porous membrane which structure comprises an electrolyte layer 1, a porous membrane reinforcing layer 2, and an electrolyte layer 3. The porous membrane 2 as reinforcing layer offers a high mechanical strength. The presence of noble metal carrying carbon 4 on a surface of and/or in pores in the porous membrane 2 allows hydrogen permeating the pores to be protonated by a chemical catalytic reaction. Further, the noble metal carrying carbon physically obstructs the hydrogen permeating the pores. As a result, the fuel cell reinforcing electrolyte membrane in accordance with the present invention suppresses the permeation of hydrogen gas to increase the utilization efficiency of hydrogen. The fuel cell reinforcing electrolyte membrane also inhibits the degradation of the electrolyte caused by the permeation of hydrogen to improve durability.

The following are examples of formulation of a plating treatment solution used if the noble metal carrying carbon 4 is present on the surface of and/or in the pores in the porous membrane in accordance with the present invention.

(1) Pt ion seed (for example, palatinate chloride, dinitrodiamine platinum, tetraamminedichloro platinum, or potassium hexahydroxo palatinate),
(2) Acid electrolyte particulates (for example, nafion solution (particle size<1 μm)
(3) Surfactant (for example, dimethylsulfoxide, any alcohol, any surfactant (cationic surfactant, anionic surfactant, or nonionic surfactant)
(4) pH controlling agent (for example, sodium hydroxide or potassium hydroxide).
(5) Complexing agent (for example, oxycarboxylic acid such as citrate or tartrate, dicarboxylic acid such as malonic acid or maleic acid, any of their salts, or any amine such as EDTA, triethanolamine, glycine, or alanine)
(6) Reducing agent (at least one of the reducing agents normally used for chemical plating, for example, hypophosphite, hydrazine salts, formalin, NaBH₄, LiAlH₆, dialkylamineboran, sulfite, and ascorbate)

A fuel electrode and an oxygen electrode are normally each composed of a catalyst layer containing a catalyst comprising carbon particles carrying platinum or the like and a diffusion layer comprising a porous material such as a carbon cloth which allows gas to be diffused. In this case, a fuel cell membrane-electrode assembly in accordance with the present invention may be provided by forming a catalyst layer and a diffusion layer on the respective sides of an electrolyte. For example, a catalyst layer is formed by dispersing the catalyst of each electrode in a liquid containing polymer that is a material for a polymer membrane constituting an electrolyte and, for example, coating and drying the fluid dispersion on the opposite surfaces of the polymer membrane. Then, a carbon cloth or the like is, for example, pressed against the surface of each catalyst layer formed to form a diffusion layer. A membrane-electrode assembly is thus obtained.

The electrolyte in the fuel cell membrane-electrode assembly in accordance with the present invention may be a plurality of reinforcing porous membrane laminated together. In this case, at least one of plurality of porous membranes is the reinforcing electrolyte membrane in accordance with the present invention. The laminated electrolyte membranes are not particularly limited provided that they are polymer membranes that can be used as an electrolyte. The laminated electrolyte membranes may each be the same electrolyte membrane or may be a mixture of different types of electrolyte membranes. Examples of the electrolyte membrane include all fluorine-containing electrolyte membranes such as an all fluorine-containing sulfonic acid membrane, an all fluorine-containing phosphonic acid membrane, and an all fluorine-containing carboxylic acid membrane, all-fluorine-containing electrolyte membranes such as a PTFE composite film obtained by combining the all fluorine-containing film with polytetrafluoroethylene (PTFE), and hydrocarbon-containing electrolyte membranes such as an all fluorine-and-hydrocarbon-containing graft membrane, an all hydrocarbon-containing graft membrane, and an all aromatic membrane.

In particular, the all fluorine-containing electrolyte membranes are desirably used in view of their durability and the like. Among the all fluorine-containing electrolyte membranes, the all fluorine-containing sulfonic acid membrane is desirable owing to its high electrolytic performance. An example of the all fluorine-containing sulfonic acid membrane is a copolymer membrane of perfluorovinylether and tetrafluoroethylene having a sulfonic acid group and called “Nafion” (registered trade mark; manufactured by Dupont).

Alternatively, in view of costs and the like, the hydrocarbon-containing electrolyte membranes are desirably used. Specific examples of the hydrocarbon-containing electrolyte membrane include a sulfonic acid type ethylenetetrafluoroethylene copolymer-graft-polystyrene membrane (hereinafter referred to as a “sulfonic acid type ETFE-g-PSt membrane”), a sulfonic acid type polyethersulfone membrane, a sulfonic acid type polyetheretherketone membrane, a sulfonic acid type cross linking polystyrene membrane, a sulfonic acid type polytrifluorostyrene membrane, a sulfonic acid type poly (2,3-difenyl-1,4-phenyleneoxide) membrane, a sulfonic acid type polyaryletherketone membrane, a sulfonic acid type poly (allylenethersulfon) membrane, a sulfonic acid type polyimide membrane, and a sulfonic acid type polyamide membrane. In particular, the sulfonic acid type ETFE-g-PSt membrane is desirably used owing to their low costs and high performance.

The thickness of the porous membrane in the reinforcing electrolyte membrane in accordance with the present invention is not particularly limited. For example, for the effective suppression of permeation of hydrogen gas, it is preferable to set the thicknesses of each catalyst layer, the entire electrolyte layer, and a single porous membrane at 1 to 10 μm, 10 to 100 μm, and 1 to 10 μm, respectively.

A solid polymer fuel cell in accordance with the present invention uses the above fuel cell membrane-electrode assembly in accordance with the present invention. The solid polymer fuel cell may be configured similarly to known solid polymer fuel cells except that the fuel cell membrane-electrode assembly in accordance with the present invention is used. The use of the fuel cell membrane-electrode assembly in accordance with the present invention provides an inexpensive, durable, and high-power solid polymer fuel cell.

### EXAMPLES

### Examples of the Invention

### Example

(1) First, 10 to 30% of isobar (brand name) and carbon was kneaded using Fine Powder 65N (brand name) manufactured by Dupont, as an assistant. The mixture was matured for 24 hours and beaded by an extruder to obtain PTFE, which was then rolled into a tape.

(2) The carbon-mixed PTFE tape produced was washed and immersed in chromium sulfate for about 1 day to clean the surface of the material. The tape was then washed in distilled water. Two carbon-mixed PTFE tapes produced were easily immersed in a plating solution containing 5 g of platinate chloride [H₂PtCl₆.6H₂O] in 150 ml of distilled water. One of the tapes was set to be a positive electrode, while the other was set to be a negative electrode. The two electrodes were used to precipitate platinum at a bath voltage of 3 V and a current density of about 0.03 to 0.05 A/cm². The electrodes were each switched between the positive and negative states about every 1 minute so as to be alternately and gradually plated. An electrolysis operation was continued for about 20 to 30 minutes until plating was completed. The carbon-mixed PTFE tapes were subsequently washed in distilled water and further immersed in distilled sulfuric acid (10%). A voltage of about 3 V was applied to the plated positive carbon-mixed PTFE tape using a new carbon-mixed PTFE tape as a negative pole. After the plating, the plating solution and adsorbed chlorine were removed. The tapes were finally washed in warm distilled water. A carbon-mixed plated PTFE tape was thus produced.

(3) The carbon-mixed plated PTFE tape produced was set in a biaxial stretching machine to form a carbon-mixed PTFE porous membrane.

(4) Electrolyte membranes of about 15 μm were laminated to the respective sides of the carbon-mixed plated PTFE porous membrane. The electrolyte membranes were pressed against the porous membrane at 230° C. for 15 minutes to produce a reinforcing composite solid polymer electrolyte membrane.

(5) The carbon-mixed plated PTFE porous reinforcing composite solid polymer electrolyte membrane was evaluated for the permeation of hydrogen gas. The electrolyte membrane exhibited a permeation constant of 2.1 (×10⁻⁹ cc/cm/cm² scmHg).

### Comparative Example

A PTFE porous reinforcing composite solid polymer electrolyte membrane was produced in the same manner as that in Example except that step (2) was not executed.

An electrolyte membrane produced exhibited a permeation constant of 5.1 (×10⁻⁹ cc/cm/cm² scmHg).

Electric conductivities measured in Example and Comparative Example were equivalent, about 0.006 s/cm. Tensile strengths measured in Example and Comparative Example were also equivalent.

### INDUSTRIAL APPLICABILITY

The electrolyte membrane for a fuel cell in accordance with the present invention offers a high mechanical strength and suppresses the permeation of hydrogen. This inhibits cross leak, in which permeating hydrogen reacts with oxygen to thermally degrade the membrane, and also inhibits short circuiting resulting from the precipitation of the noble metal. The durability and lifetime of the fuel cell can thus be reduced. The use of the fuel cell membrane-electrode assembly inhibiting cross leak provides a durable, high-power solid polymer fuel cell. This contributes to the practical application and prevalence of fuel cells.

1. A fuel cell reinforcing electrolyte membrane reinforced by a porous membrane, characterized in that noble metal carrying carbon is present on a surface of and/or in pores in the porous membrane.

2. The fuel cell reinforcing electrolyte membrane reinforced by a porous membrane according to claim 1, characterized by comprising the porous membrane having the noble metal carrying carbon present on the surface thereof and/or in the pores therein and a polymer electrolyte with which the porous membrane is impregnated and/or which is laminated to the porous membrane.

3. The fuel cell reinforcing electrolyte membrane reinforced by a porous membrane according to claim 1 or 2, characterized by comprising one or more laminated sets of the polymer electrolyte membrane and the porous membrane.

4. The fuel cell reinforcing electrolyte membrane according to any of claims 1 to 3, characterized in that the porous membrane is a polytetrafluoroethylene (PTFE) membrane made porous by drawing.

5. The fuel cell reinforcing electrolyte membrane according to any of claims 1 to 4, characterized in that the noble metal is platinum (Pt).

6. A method for manufacturing a fuel cell reinforcing electrolyte membrane, characterized by comprising a step of mixing a polymer material powder that can be formed into a porous membrane and a carbon powder and extruding the mixture to manufacture a carbon mixed polymer membrane, a step of treating the carbon mixed polymer membrane with a compound solution having a noble metal ion seed to allow carbon present in the polymer membrane to carry the noble metal, a step of drawing the porous membrane to form a porous thin membrane, and a step of impregnating and/or laminating the porous membrane having the noble metal carrying carbon present on a surface thereof and/or in pores therein, with and/or to a polymer electrolyte.

7. The method for manufacturing a fuel cell reinforcing electrolyte membrane according to claim 6, characterized in that the step of coating and/or precipitating the noble metal on the surface of and/or in the pores in the porous thin membrane is chemical plating or sputtering.

8. The method for manufacturing a fuel cell reinforcing electrolyte membrane according to claim 6 or 7, characterized in that the step of impregnating and/or laminating the porous membrane with and/or to the polymer electrolyte is casting or melt impregnation.

9. The method for manufacturing a fuel cell reinforcing electrolyte membrane according to claims 6 to 8, characterized in that the polymer material that can be formed into the porous membrane is a polytetrafluoroethylene (PTFE) membrane.

10. The method for manufacturing a fuel cell reinforcing electrolyte membrane according to any of claims 6 to 9, characterized in that the noble metal is platinum (Pt).

11. A fuel cell membrane-electrode assembly including a pair of electrodes comprising a fuel electrode to which fuel gas is supplied and an oxygen electrode to which an oxidizer gas is supplied and a polymer electrolyte membrane sandwiched between the pair of electrodes, characterized in that the polymer electrolyte membrane is the fuel cell reinforcing electrolyte membrane according to any of claims 1 to 5.

12. A solid polymer fuel cell comprising a membrane-electrode assembly having the fuel cell reinforcing electrolyte membrane according to any of claims 1 to 5.
